(19) United States
(12) Patent Application Publication
(10) Pub. No.: US 2006/0055085 A1
(43) Pub. Date: Mar. 16, 2006

(54) Layered metal mold and method of using the same for molding

(75) Inventors: Takeo Nakagawa, Kawasaki-city (JP); Hisao Yamazaki, Hiroshima-city (JP); Hideo Yoshimura, Hiroshima-city (JP); Masanori Kunieda, Tokyo (JP); Akira Sato, Tokorozawa-city (JP); Masayuki Suzuki, Takahama-city (JP)

Correspondence Address: Barry E. Bretschneider;Morrison & Foerster LLP, Suite 300, 1650 Tysons Boulevard, McLean, VA, 22102, US

(73) Assignees: Tokyo University of Agriculture and Technology, Fuchu-city (JP); Sekisou Forming Tool Laboratories, Hiroshima-city (JP)

(21) Appl. No.: 11/078,710

(22) Filed: Mar. 14, 2005

(30) Foreign Application Priority Data
Sep. 14, 2004 (JP) 2004-267431

(51) Int. Cl. B29C 45/00; B29B 7/00

(52) U.S. Cl. 264/328.16

(57) ABSTRACT

This invention is to offer the metal mold for injection molding and the metal mold for diecast molding with an excellent temperature controlling property that can be manufactured with lower manufacturing cost and shorter manufacturing time. The purpose of this invention is to offer the method to use the metal mold for injection molding capable of producing accurate products. The metal mold 1 for injection molding has the fixed metal mold part 2 configured by processing, layering and bonding a plurality of metal plates 10, the movable metal mold part 4 configured by processing, layering and bonding a plurality of metal plates 13, and the temperature controlling passages 3 and 5 formed by processing, layering and bonding a plurality of metal plates 10 and 13 in at least, one of the fixed metal mold part 2 and the movable metal mold part 4.

### BACKGROUND OF THE INVENTION

1. Field of Invention

This invention relates to a layered metal mold and a method of using the metal mold for injection molding and diecast molding.

2. Description of Related Art

The reduction of molding cycle has been sought out to improve the productivity in the field of injection molding and diecast molding. Although the faster cooling process is desirable for the reduction of the molding cycle, the residual warp or the deformation takes place in the finished product because of the uneven temperature distribution in the metal mold, if the cooling process is not performed properly. Therefore, adjusting the temperature distribution in the metal mold is extremely important. Usually, a water passage, in which water runs through, is formed in the metal mold for the adjustment of the temperature distribution. The size of the cooling area and the location of the water passage is crucial to the effective cooling process. Much effort has been made for forming the effective metal mold for injection molding and the mold for diecast molding.

A method of forming a water passage for cooling inside a core and a method of having water run through the passage is disclosed in Japanese Patent Application Publication No. 64-26421 as a cooling method for the metal mold with a narrow core for injection molding. It is very difficult to cool down the core of the deep and large molding product when the injection molding is employed. The technology to form a ditch in such way that water coming from the center of the core goes through from a gate part to a tip of a cavity part is disclosed in “Mold for Injection Molding,” Nikkan-Kogyo-Shinbunsha, p 23, 1986.

The effort for the efficient cooling process has also been made in the metal mold for the diecast molding. For example, it is difficult to form a ring-shape hole for cooling agent by using a drill or to make the hole inside mold near the gate if the entire lower part of the metal mold is formed as one part. The technology of forming the passage for cooling agent, divide the lower part of the metal mold into several portions, form each portion separately, form a ditch at the area where the portions meet, and seal the ditch is disclosed in Japanese Patent Application Publication No. 9-277009.

As to the technology disclosed in No. 64-26421, the metal mold has a relatively simple structure and its manufacturing method is also simple. However, the area for the heat exchange is usually small, and therefore, the cooling ability is, in some cases, not enough. Therefore, it is difficult to apply this technology for a large and deep molding product. The technology disclosed in Mold for Injection Molding can accommodate the larger heat transfer area. However, forming water passage for cooling with this technology requires complicated processes. First, the inside of the core should be hollow. Then, a ditch for cooling is formed on the outer surface of a part with the same shape as the hollow. This part is then fitted in the hollow part of the core, making a ditch for cooling. This manufacturing method of the metal mold is complicated and requires long time. Also the sealing of the ditch is difficult. Short pass of the cooling water sometimes takes place. Since the ditch for cooling is formed by machine processing, it requires long manufacturing time and it is not suitable for minute processing.

As to the technology disclosed in No. 9-277009, the manufacturing of the metal mold requires the long time, because the passage for the cooling agent is formed by dividing the lower part of the metal mold into portions, forming a ditch at the area where the portions meet, and sealing the ditch. Also, it is very difficult to produce the metal mold when a ditch should be formed according to the shape of the cavity. The same can be said to the technology in Mold for Injection Molding.

### SUMMARY OF THE INVENTION

The invention provides a metal mold that includes a first metal part having a plurality of metal plates and a second metal part having a plurality of metal plates. The first and second metal parts define a molding cavity. The metal mold also includes a passage for a temperature controlling agent formed in at least one of the first and second metal parts.

The invention also provides a metal mold including a first metal part having a plurality of metal plate, a second metal part having a plurality of metal plates, and a passage for a coolant formed in at least one of the first and second metal parts.

The invention further provides a method of injection molding that includes providing a metal mold including a first metal part having a plurality of metal plates, a second metal part having a plurality of metal plates, the first and second metal parts defining a molding cavity, and a passage for a fluid formed in at least one of the first and second metal parts. The method also includes introducing a heating agent into the passage to preheat the metal mold, injecting a resin into the molding cavity of the preheated metal mold, and introducing a cooling agent into the passage of the metal mold containing the injected resin.

### BRIEF DESCRIPTION OF THE DRAWINGS

FIG. 1 shows a part of cross-sectional view of the metal mold for injection molding as an embodiment of this invention.

FIG. 2(a) and FIG. 2(b) are the plan view and the front view of the temperature controlling passage in the fixed metal mold part of the metal mold for the injection molding shown in FIG. 1.

FIG. 3(a) and FIG. 3(b) are the plan view and the front view of the temperature controlling passage in the movable part of the metal mold for the injection molding shown in FIG. 1.

FIG. 4 is a cross-sectional view of the FIG. 2(a) along the cross-section line IV-IV.

FIG. 5 is a cross-sectional view of the FIG. 3(a) along the cross-section line V-V.

FIG. 6 is a flow chart showing the manufacturing method of the metal mold for injection molding as an embodiment of this invention.

FIG. 7 shows a part of cross-sectional view of the metal mold for diecast molding as an embodiment of this invention.

FIG. 8 is a cross-sectional view of the FIG. 7 along the cross-section line VIII-VIII.

FIG. 9 is a view to explain the pressure method of the diffusion welding for the fixed metal mold part of the first embodiment of this invention.

FIG. 10 shows the cooling property of the metal mold for injection molding of the first embodiment.

FIG. 11 is a graph showing the warp of the finished product manufactured by using the metal mold for injection molding of the first embodiment of this invention.

FIG. 12 shows the measurement of each part of the finished product manufactured by using the metal mold for injection molding of the first embodiment of this invention.

### DETAILED DESCRIPTION OF THE INVENTION

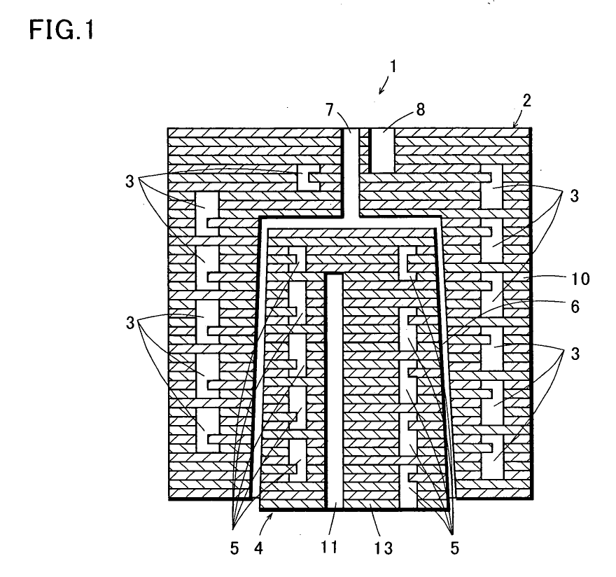

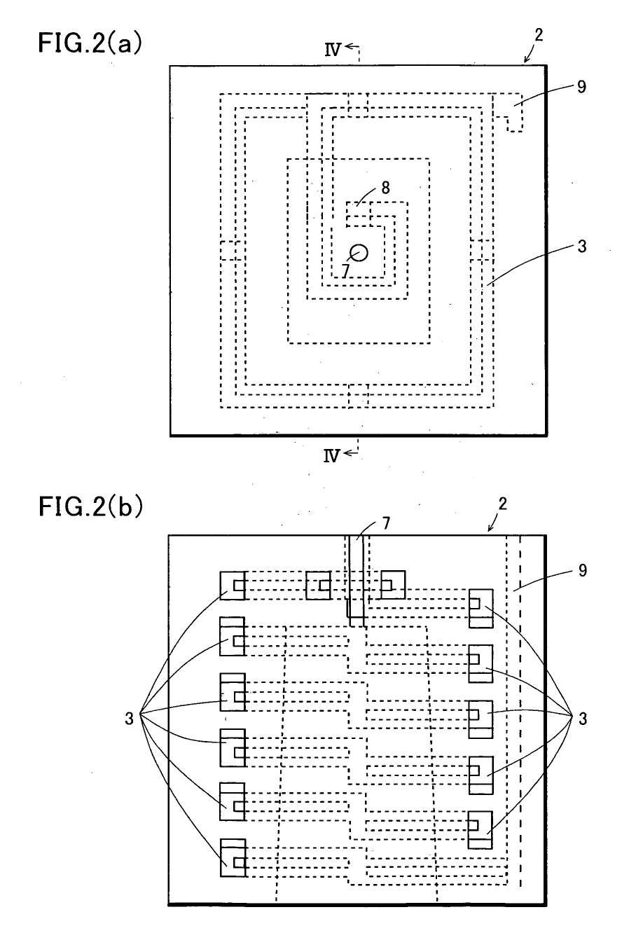

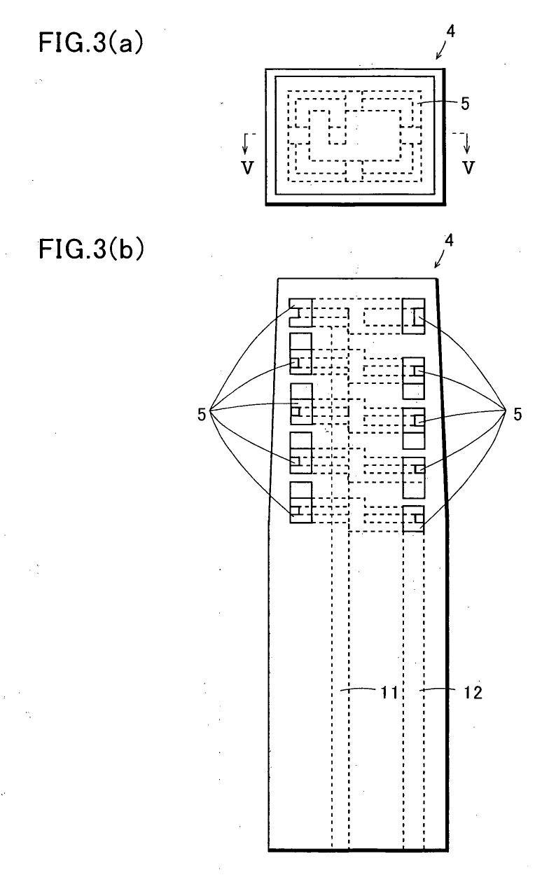

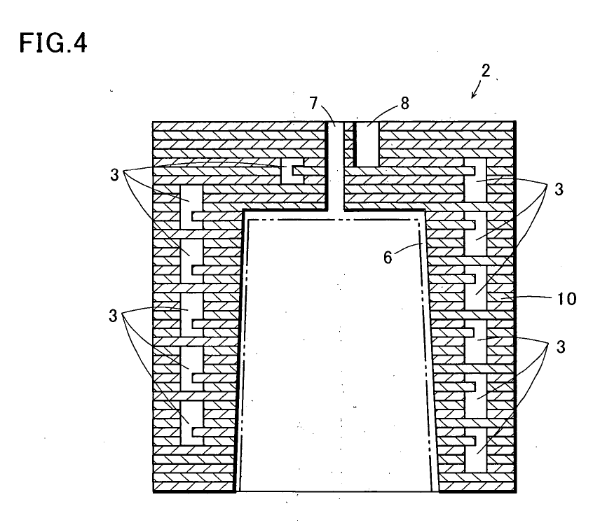

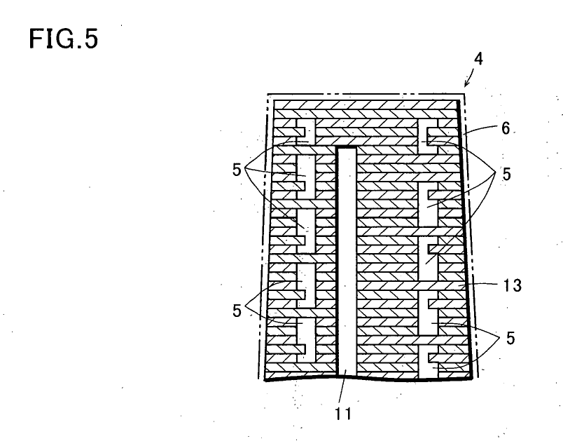

FIG. 1 shows a part of cross-sectional view of a metal mold 1 for injection molding as an embodiment of this invention. FIG. 2 shows a temperature controlling passage 3 in a fixed metal mold part 2 of the metal mold 1 for the injection molding shown in FIG. 1. FIG. 3 shows a temperature controlling passage 5 in a movable part 4 (core) of the metal mold 1 for the injection molding shown in FIG. 1. FIG. 4 is a cross-sectional view of the FIG. 2(a) along the cross-section line IV-IV. And FIG. 5 is a cross-sectional view of the FIG. 3(a) along the cross-section line V-V.

The metal mold 1 for injection molding shown in FIGS. 1-5 is the metal mold for thin and deep product. The metal mold 1 for injection molding include the fixed metal mold part 2 and the movable metal mold part 4 (core) as shown in FIG. 1. The fixed metal mold part 2 has temperature controlling passage 3 along a cavity 6 as shown in FIG. 2(b), which is the frontal view, and FIG. 4. Also, the temperature controlling passage is configured in a spiral shape as shown in FIG. 2(a), which is a plan view. The temperature controlling passage has an entrance 8 near a gate 7. A heating agent or a cooling agent for temperature control runs through the spiral passage and goes out from the upper part of the fixed metal mold part 2 through an outlet 911. The fixed metal mold part 2 is configured by layering a plurality of metal plates 10 as shown in FIG. 1 and FIG. 4. The temperature controlling passage 3 is also configured by processing and layering the metal plate 10.

Likewise, the movable metal mold part (core) 4 also has a temperature controlling passage 5 along the cavity 6 as shown in FIG. 3(b), which is a frontal view and FIG. 5. The temperature controlling passage 5 has an entrance 11 near the central part of the movable metal mold part (core) 4. The temperature controlling agent runs through the spiral passage from the tip of the movable metal mold part (core) 4 and goes out from the lower part of the movable metal mold part (core) 4 through the outlet 12. The movable metal mold part 4 is also configured by layering a plurality of metal plates 13 as shown in FIG. 1 and FIG. 4. The temperature controlling passage 5 is also configured by processing and layering the metal plate 13.

Both the fixed metal mold part 2 and the movable metal mold part (core) 4 have the temperature controlling passages 3 and 5 along the cavity 6. Therefore, cooling of the product can be efficiently performed. The cross-section of the temperature controlling passage has a fin-shape in this embodiment as shown in FIGS. 4 and 5, which further improve the heating or cooling efficiency. Also, since the temperature controlling passages 3 and 5 are formed in spiral configuration in this embodiment, it is possible to have a larger cooling area. The temperature controlling of the metal molds 2 and 4 can be performed easily by forming the temperature controlling passages 3 and 5.

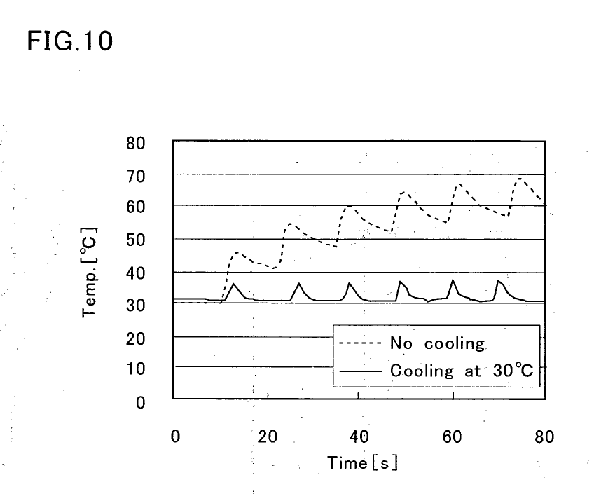

The metal mold 1 for injection molding has the excellent temperature controlling ability as shown in an embodiment (refer to FIG. 10) described later. This can be contributed to the fact that the metal mold has a larger heat exchange surface area and that the temperature controlling passage is formed near the cavity. The injection molding can be performed easily by letting the heating agent and cooling agent run through the temperature controlling passages 3 and 5, maximizing the benefit of the high heat exchanging ability of the metal mold 1 for injection molding.

The injection molding is done by following the steps described below. The heating agent is put into the temperature controlling passages 3 and 5 before resin is injected for preheating the metal mold. The heating agent can be-heated oil, hot water or steam depending on the desirable temperature for preheating. The desirable temperature can be determined according to the resin to be injected. The fluidity of the resin upon the injection is improved because the metal mold is preheated before the injection. The better fluidity of resin leads to the decreased thickness of the product and the better transferability of resin. It is also effective to prevent warp of the product and to reduce the residual stress caused by the hardening process of the resin.

The cooling agent is put into the temperature controlling passages 3 and 5 for cooling down the metal mold after the injection of the resin into the metal mold. It is possible to ease the conditions for injection molding and shorten the injection molding cycle by following the steps described above. The temperature controlling passage formed in conventional metal mold has a smaller heat exchange surface area and a poor cooling ability because of the longer distance between the cavity and the temperature controlling passage. Therefore, the temperature of the metal mold does not follow the temperature of the temperature controlling agent quickly enough to perform the heating operation and the cooling operation alternatively. However, the metal mold 1 for injection molding of this embodiment can accommodate such operation because it has a high cooling efficiency.

It is also possible to form the passage for heating agent and the passage for cooling agent separately in each of the fixed metal mold part 2 and the movable metal mold part 4.

The temperature controlling passages 3 and 5 are formed in both the fixed metal mold part 2 and the movable metal mold part (core) 4 in the embodiment of this invention. However, it is not necessary to form the passage in the both metal mold parts. Also, the temperature controlling passages 3 and 5 are formed along the cavity 6 to cover the entire cavity area in the embodiment of this invention. However, the temperature controlling passages 3 and 5 can also be formed to cool down only a part of the cavity 6.

For example, if temperature of a certain area of the cavity is expected to be high due to the shape of the cavity, the passage should be formed inside the metal mold near the area where the temperature is expected to be high. The temperature can be distributed evenly by letting the cooling agent run through the temperature controlling passage, achieving the accurate finished product with no warp. The temperature controlling passages 3 and 5 may be modified according to the purpose of the metal mold 1 for injection molding as it is explained.

To form the complicated temperature controlling passages 3 and 5 shown in FIGS. 1-5 is very difficult when the metal mold is manufactured by processing a metal block using a machine as in conventional arts. However, it is easier to form the fine passage and the passage with a complicated route in this embodiment because the metal mold is configured by processing, layering and bonding a plurality of thin metal plates 10 and 13.

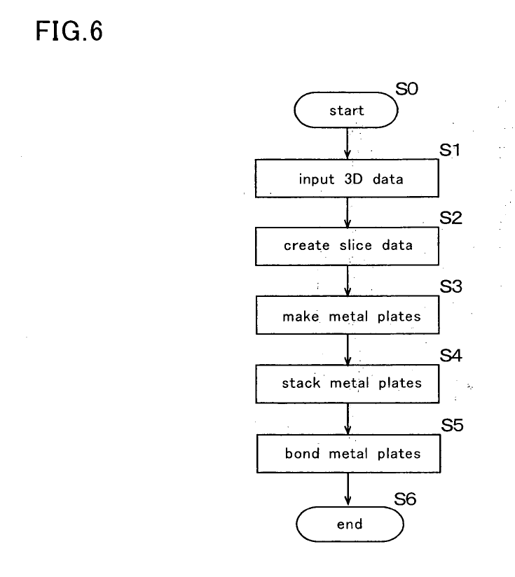

FIG. 6 is a flow chart showing a manufacturing method of the metal mold 1 for injection molding. The chart only shows one example of the manufacturing method. However, the combination and the order of the steps S1-S5 can be changed.

In step 1, the three-dimensional CAD data of the metal mold is inputted into a computer. The computer creates a slice data based on the inputted three-dimensional CAD data using a calculation device at step 2. The calculation device creates the slice data for metal plates 10 and 13 with a predetermined thickness from the three-dimensional CAD data based on the program for creating the slice data stored in the computer memory to create the metal plates at step 3. The slice data includes the data for the shape of the finished product, the data regarding the temperature controlling passage, and the data of the location of positioning holes for layering the metal plates. When the metal plates 10 and 13 are not pre-cut into the predetermined size, the data for the size of the metal plates 10 and 13 is also acquired.

The thickness of the metal plates 10 and 13 is predetermined based on the processing ability of the machinery used. However, it is desirable to take the shape of the temperature controlling passages 3 and 5 into consideration when the thickness of the metal plate is determined. The temperature controlling passages 3 and 5 are formed by layering the metal plates 10 and 13 with the part of the passages cut out by laser as shown in FIGS. 4 and 5. Therefore, the size of the temperature controlling passages 3 and 5 largely depends on the thickness of the metal plates 10 and 13. The metal plates 10 and 13 with the same thickness are used in the embodiment shown in FIGS. 1-5. However, the thicker metal plate can be used to shorten the manufacturing time of the metal mold in the area where no temperature controlling passage is formed, because there is no need to consider the shape of the passage. Even in the area where the temperature controlling passage is formed, it is not necessary for the thickness of the metal plates 10 and 13 to be exactly the same.

The material used for the metal plate can be determined according to the purpose of the metal mold and the specification of the processing device. The entire metal mold can be made of the same material. It is also possible to make the metal mold from different kinds of materials. For example, when the temperature controlling passages 3 and 5 for cooling are formed in the metal mold, copper or copper alloy, which has a high thermal conductivity, can be employed for the area where the temperature controlling passages 3 and 5 are formed. And stainless steel can be employed in the area where the strength is required. The selection of the material for the metal plates is made according to the necessity of each part. Since the selection of the material for the metal plate can be made by taking the property of the material into consideration, it is possible to shorten the processing time, leading to the shorter manufacturing time of the metal mold.

The processing of the metal plate is performed at step 3. The processing of the metal plate includes the processing of the surface of the finished product and the formation of the temperature controlling passages 3 and 5. Also, the positioning hole for determining the location of the metal plates 10 and 13 for layering is also processed according to the necessity at this step. The metal plates 10 and 13 are cut out into a certain size at this step when the precut metal plates 10 and 13 with the predetermined size are not used. The processing of the each metal plate, which is layered for configuring the layered metal mold, is relatively easy. Therefore, the metal mold with the temperature controlling passage of the complicated shape can be manufactured for the shorter manufacturing time. If the thinner metal plats are used, it is possible to acquire very fine passage. It is also relatively easy to have the temperature controlling passages 3 and 5 near the cavity 6.

The cross-sectional shape of the temperature controlling passages 3 and 5 is basically rectangular because the passages are formed by processing the metal plates 10 and 13. Therefore, the larger thermal conduction area can be obtained near the cavity compared to the case where passages are circular ditches. Additionally, it is possible to make the cross-sectional shape of the temperature controlling passages 3 and 5 a fin-shape, as shown in FIGS. 1-5. The thickness of the fin is the thickness of the metal plate that makes the formation of the passage relatively easy. The main task of step 3 is cutting of the metal plate. Leaser cutting, plasma cutting and milling cutting can be employed for this step. These cutting methods can be employed independently or combined. The ordinary polishing method, such as polishing using a grinder, is effective to remove rough edge and dust, if they appear at the cut area.

The metal plates are layered in a predetermined location in the predetermined order at step 4. The metal plates can be layered with the V-block as the standard surface when the outline shape of the metal plates is about the same as in the embodiment of this invention. Also, the positioning hole, in which a positioning pin is inserted, can be formed in the metal plate. The layering process can be divided into several stages if the bonding of the layered metal plates is performed a plurality of times.

The bonding of the layered metal plates is performed at step 5 after the physical stacking. The bonding of the metal plates includes the spot welding, seam welding, use of brazing insert such as copper and silver, use of solder, and use of other adhesives. It is desirable to employ the diffusion welding because it has excellent sealing characteristics. If the bonding between the metal plates is weak, the leakage of the temperature controlling agent may take place. The weak bonding between the metal plates also causes the invasion of the resin between the metal plates, which is fatal for molding. If the thin film of brazing solders is used to bond the metal plates for making a metal mold with the fine passage, there is a possibility for the melted solders to close the passage. The diffusion welding does not have those problems.

The diffusion welding is the method of bonding the metal plates by utilizing the diffusion of atoms that takes place at the surface of the metal plates when they are tightly put together at a sufficiently high temperature, but below the melting temperature of the metal plates. The diffusion welding is performed by the ordinary method that includes the placement of the layered metal plates in the vacuum furnace, application of the pressure to the layered metal plates, and the application of the heat to the layered metal plates. The bonding would be weaker if the application of the pressure is not strong enough in the diffusion welding. Therefore, if the enough pressure cannot be applied as in the case of the fixed metal mold part 2 where the cavity 6 and the temperature controlling passage 3 are superimposed each other in the direction of the pressure application, it is necessary to apply the enough pressure by performing the diffusion welding twice as shown in the first embodiment of this invention as described later. Also, the welding may become easier by applying the different insert material to the surface for the welding.

The metal plates 10 and 13 are used for the layered metal body in the above embodiment. It is also possible to manufacture the metal mold by using a metal block as a part of the metal mold and layering the metal plates for the other part of the metal mold. For example, the metal block can be used for the part of the movable metal mold part 4 where there is no spiral temperature controlling passage 5. The processing and the manufacturing time of the metal mold should be taken into consideration for determining if the metal block should be used for manufacturing the metal mold.

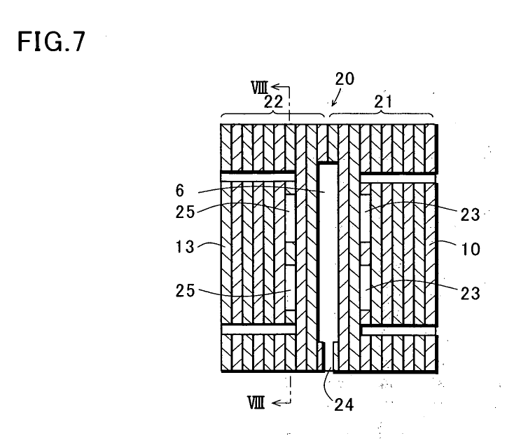

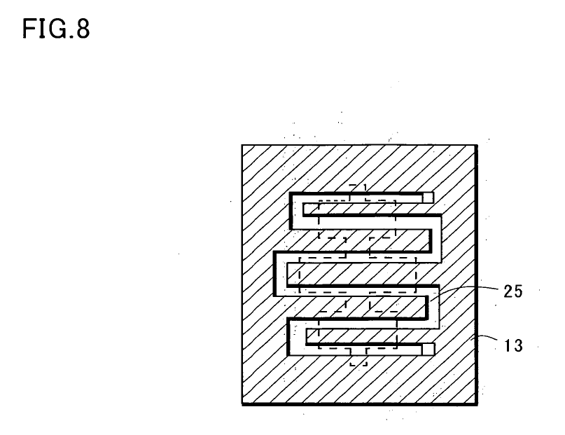

FIG. 7 shows a part of cross-sectional view of the metal mold 20 for diecast molding as an embodiment of this invention. FIG. 8 is a cross-sectional view of the FIG. 7 along the cross-section line VIII-VIII. The same reference numerals for the parts in the embodiment shown in FIGS. 1-5 are given to the corresponding parts and explanation for these parts is omitted. The metal mold 20 for diecast molding has a fixed metal mold part 21 and a movable metal mold part 22. Both the fixed metal mold part 21 and the movable metal mold part 22 include the layered metal plates 10 and 13.

The fixed metal mold part 21 has a cooling passage 23 for cooling down the cast product of the diecast molding. The cooling passage 23 is formed along the cavity 6. The cooling agent enters from the lower part and is exhausted from the upper part of the fixed metal mold part 22. Likewise, the movable metal mold part 22 has a cooling passage 25 for cooling down the cast product of the diecast molding. The cooling passage 25 is formed along the cavity 6. The cooling agent enters from the lower part and is exhausted from the upper part of the fixed metal mold part 22.

The metal mold 20 for diecast molding has the cooling passages 23 and 25 along the cavity 6. Therefore, cooling of the product can be efficiently performed. The processing to form the passage with a complicated route is relatively easy because the metal mold 20 for diecast molding is configured by processing the metal plates 10 and 13, leading to the shorter manufacturing time of the metal mold 20. The cooling passage is formed in both the fixed metal mold part 21 and the movable metal mold part 22 in the embodiment of this invention.

However, it is not necessary to form the passage in the both metal mold parts. Also, the cooling passage can be formed to cool down only a part of the cavity 6, as it is the case for the metal mold for injection molding. The manufacturing method of the metal mold for the diecast molding is the same as that of the metal mold for injection molding shown in FIG. 6. The explanation of the manufacturing method is omitted.

An example of manufacturing the metal mold for injection molding with a complicated route by layering the metal plates is explained. The metal mold for injection molding in this example is a thin and deep product with the size of 0.4 mm in thickness, 30 mm in height, 22 mm in length and 17 mm in width. The shape of the metal mold is the same as the shape shown in FIGS. 1-5. Carbon tool steel SK5 with the thickness of 1 mm is used for the metal plate. The metal plate is cut by using laser based on the slice data. The rough edge is removed by grinding stone and organic contamination is removed by ethanol. Then, the metal plates are stacked using the V block as a guide. The layered body is temporarily put together using a super glue. Then, the layered body is put in the vacuum furnace and bonded by the diffusion welding.

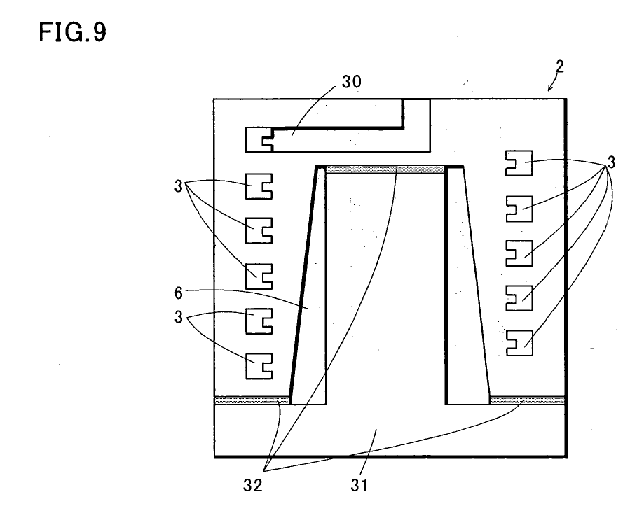

The application of bonding pressure starts as soon as the layered body is set in the furnace to prevent the toppling of the layered body. The diffusion welding is performed after the temperature inside the furnace goes up. The pressure inside the furnace is 1×10⁻⁴ Torr (0.013 Pa). The bonding of the core, which is the movable metal mold part, is performed with the bonding pressure of 6.9 MPa under the temperature of 110° C. for 180 minutes. Since the fixed metal mold part 2 has the temperature controlling passage 30 above the surface of the cavity 6 as shown in FIG. 9, the bonding strength around the temperature controlling passage 30 is expected to be weak because this area does not receive enough pressure during the diffusion welding. Therefore, the area configuring the cavity 6 is bonded first, and then the layered body around the gate is bonded together with the layered body configuring the cavity 6. The bonding is performed with the bonding pressure of 4.9 MPa under the temperature of 850° C. for 180 minutes. The application of the pressure around the gate is performed with a spacer 31, which is the layered body placed in the cavity 6 configured with the same number of the metal plates, and the separating agent 32 applied between the fixed metal mold part and the spacer.

The effectiveness of cooling is shown in FIG. 10. FIG. 10 shows the temperatures of the tip of the movable metal mold part when cooling water of 30° C. is applied in both the fixed metal mold part and the movable metal mold part and when cooling water is not applied either in the movable metal mold part or the fixed metal mold part. The cooling time was 3 seconds for each application. The measurement of the temperature is performed by putting a thermocouple at the location 2 mm away from the finished surface of the tip of the movable metal mold part. The temperature of the tip of the core goes down after the separation when cooling water is applied as shown in FIG. 10. The cooling of the core can shorten the molding cycle. The temperature of the surface of the finished product can be reduced to the temperature of the cooling water quickly.

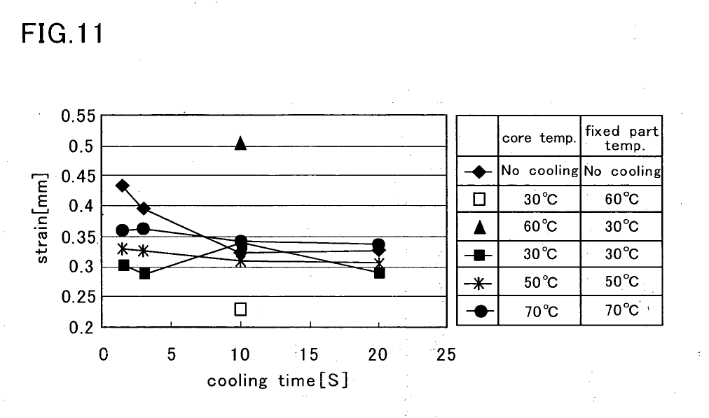

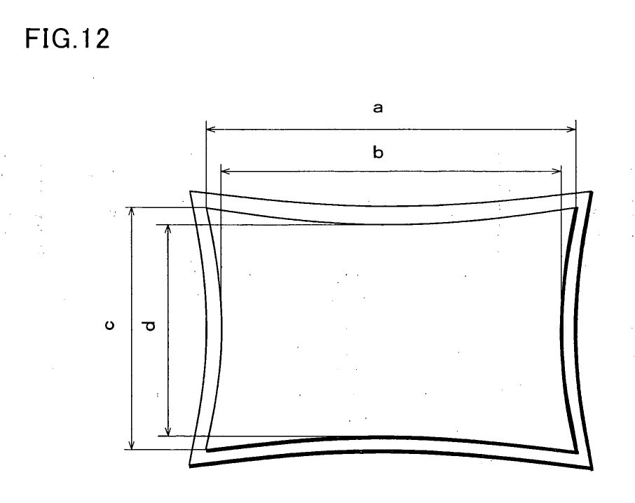

FIG. 11 shows the results of the measurements of the warp defined in the following equation (1) using the parameters shown in FIG. 12.

$$warp = \frac{( a - b ) + ( c - d )}{2} \qquad ( 1 )$$

As shown in FIG. 11, the warps are reduced when the temperature of the core is lower than the temperature of the fixed metal mold part.

What is claimed is:

1. A metal mold comprising:
a first metal part comprising a plurality of metal plates;
a second metal part comprising a plurality of metal plates, the first and second metal parts defining a molding cavity; and
a passage for a temperature controlling agent formed in at least one of the first and second metal parts.

2. The metal mold of claim 1, wherein the passage is formed along the molding cavity.

3. The metal mold of claim 1, wherein the passage forms a spiral.

4. The metal mold of claim 1, wherein the metal plates of the first and second metal parts are connected to each other by diffusion welding.

5. The metal mold of claim 1, wherein the metal plates of the first metal part or the second metal part that includes the passage are cut to define the passage.

6. The metal mold of claim 1, wherein the passage is disposed adjacent part of the molding cavity giving rise to a high temperature during an injection process.

7. A metal mold comprising:
a first metal part comprising a plurality of metal plates;
a second metal part comprising a plurality of metal plates; and
a passage for a coolant formed in at least one of the first and second metal parts.

8. The metal mold of claim 7, wherein the metal plates of the first metal part or the second metal part that includes the passage are cut to define the passage.

9. A method of injection molding, comprising:
providing a metal mold comprising a first metal part comprising a plurality of metal plates, a second metal part comprising a plurality of metal plates, the first and second metal parts defining a molding cavity, and a passage for a fluid formed in at least one of the first and second metal parts;
introducing a heating agent into the passage to preheat the metal mold;
injecting a resin into the molding cavity of the preheated metal mold; and
introducing a cooling agent into the passage of the metal mold containing the injected resin.

10. The method of claim 9, wherein the passage of the metal mold is disposed along the molding cavity.

11. The metal mold of claim 9, wherein the passage of the metal mold forms a spiral.

12. The metal mold of claim 9, wherein the metal plates of the first and second metal parts of the metal mold are connected to each other by diffusion welding.
